(19) United States
(12) Patent Application Publication
(10) Pub. No.: US 2010/0244705 A1
(43) Pub. Date: Sep. 30, 2010

(54) Detecting Screen Breakage in Display Systems

(76) Inventors: Roger A. Hajjar, San Jose, CA (US); David L. Kent, Framingham, MA (US); Akihiro Machida, Sunnyvale, CA (US)

Correspondence Address: FISH & RICHARDSON, PC, P.O. BOX 1022, MINNEAPOLIS, MN, 55440-1022, US

(21) Appl. No.: 12/413,481

(22) Filed: Mar. 27, 2009

(51) Int. Cl. H01J 7/42; G09G 3/20

(52) U.S. Cl. 315/129; 345/55

(57) ABSTRACT

Display systems, devices and techniques based on a screen and a mechanism that detects breakage on the screen and interrupts the operation of the screen when a screen breakage is detected.

### BACKGROUND

This patent document relates to display screens, display device and systems.

A display system can be designed to use a screen to display images. For example, a TV set with a plasma flat panel screen energizes plasma pixilated cells to emit visible light for forming images. A TV set with a liquid crystal display (LCD) panel sends light through the LCD panel with LCD pixilated cells to modulate the light for forming images. A display system can also use laser light to create images on a screen.

### SUMMARY

This document describes, among others, implementations of display systems, devices and techniques based on a screen and a mechanism that detects breakage on the screen and interrupts the operation of the screen when a screen breakage is detected.

In one aspect, a display device is described to include a display screen assembly that produces images in response to one or more screen control signals. The display screen assembly includes screen sensors spatially distributed at different locations in the display screen assembly and connected to form one or more continuous conductive paths and each conductive path carries a sensor signal indicating presence or absence of a discontinuity of the display screen assembly at or near the respective conductive path. A screen control module is included in this device and receives the sensor signal carried by the one or more screen sensors. The screen control module affects the one or more screen control signals to the display screen assembly to interfere with producing of the images at a region in a respective conductive path that the sensor signal indicates a discontinuity.

In another aspect, a display device is described to include a light source module that produces one or more scanning optical beams having optical pulses to carry image information and a display screen positioned to receive the one or more scanning optical beams from the light source module. The display screen includes different light-emitting regions that absorb the one or more scanning optical beams to emit visible light forming images and a screen sensor that includes electrically conductive segments spatially distributed at different locations of the display screen and connected to form a continuous electrically conductive path to carry a sensor signal indicative of a damage in the display screen when the damage in the screen breaks the conductive path of the screen sensor. This device includes a light shut-off control module that receives the sensor signal from the screen sensor and controls the light source to shut off the one or more scanning optical beams when the sensor signal indicates a damage in the display screen.

In yet another aspect, a method is described for detecting discontinuities in a display screen assembly. This method includes energizing one or more conductive paths in a display screen assembly that are formed by connecting conductive segments spatially distributed at different locations in the display screen assembly to effectuate a screen sensor that carries a sensor signal to indicate one or more discontinuities in the one or more conductive paths; and controlling the display screen assembly to substantially remove images displayed on the display screen assembly at a location on the screen display assembly in response to the sensor signal when the sensor signal indicates presence of one or more discontinuities in the display screen assembly.

These and other aspects, and associated features and implementations are described in detail in the drawings, the detailed description and the claims.

### BRIEF DESCRIPTION OF THE DRAWINGS

FIG. 1 shows an example of a display screen assembly with an on-screen sensing mechanism for detecting breakage of the screen.

FIG. 2 shows an example of a laser display system implementing an on-screen sensor for detecting screen breakage and a control that shuts off the scanning light in response to an occurrence of the screen breakage.

FIG. 3 shows an example of a on-screen sensor that connects spatially distributed resistors for detecting screen breakage.

FIG. 4 shows a scanning beam laser display based on the on-screen sensor and control in FIG. 3.

FIG. 5 shows an example of the screen sensor based on the phosphor-based screen design in FIG. 4 with light-emitting phosphor stripes.

FIG. 6 shows another example of the screen sensor based on the phosphor-based screen design in FIG. 4 with light-emitting phosphor stripes and a color filter layer as a contrast enhancement layer.

FIG. 7 shows another example of the screen sensor based on the phosphor-based screen design in FIG. 4 with light-emitting phosphor stripes.

FIG. 8 shows an example of a laser control circuit in connection with an on-screen sensor.

FIG. 9 shows an example of a phosphor-based screen for the system in FIG. 4 and associated different layers in the screen for implementing the on-screen sensor.

### DETAILED DESCRIPTION

A display screen in various TV sets and display systems may be damaged by various causes, such as a collision of the screen with another object, significant changes in temperature or humidity at the screen or aging of one or more components of the screen. Such a screen damage can cause a hazardous condition when the screen is operated to display images. For example, a damage to a plasma or LCD flat panel screen may cause an electrical hazard when the screen is powered on. A screen that receives modulated light carrying images to display the images may leak light to the viewer when damaged. The leaked light may cause injury to the viewer, e.g., causing light-induced burn to the eye or skin. Therefore, it may be desirable in various display systems to implement a screen sensor that is embedded in the screen to detect presence or absence of a damage or crack on the screen. When the screen sensor detects the screen damage, the operation of the screen is interrupted to avoid the electrical or optical hazard condition that may be caused by the screen damage.

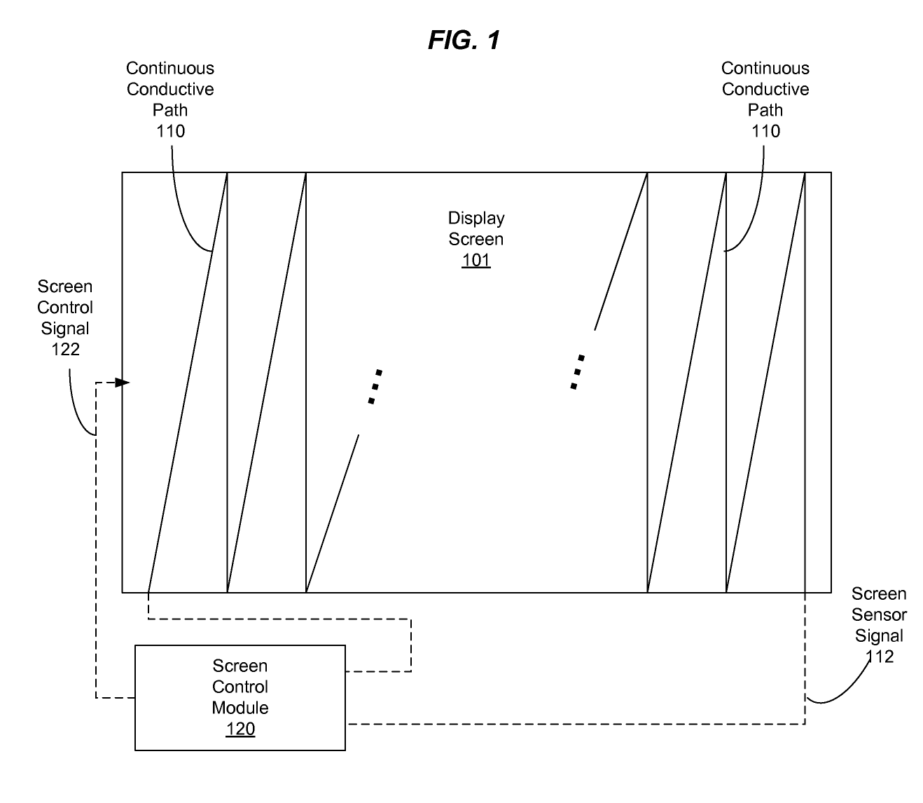

FIG. 1 shows an example of a display screen assembly that has a screen 101 produces images in response to one or more screen control signals 122 from a screen control module 120. The display screen assembly includes screen sensors that are spatially distributed at different locations in the display screen 101 and are connected to form one or more continuous conductive paths 110. Each conductive path 110 is used to carry a sensor signal 112 indicating presence or absence of a discontinuity of the display screen 101 at or near the respective conductive path. One example for the conductive path 110 is an electrically conductive path. The conductive paths 110 of the screen sensors spatially overlap with an image displaying area of the display screen 101 and are structured in a way that does not interfere with displaying of the images on the display screen 101. The conductive paths 110 can be designed to be invisible or imperceptible to a viewer under the normal viewing condition. In FIG. 1, the display screen 101 and the screen sensing mechanism can be implemented based on various display technologies, such as a liquid crystal display panel, light emitting pixel elements that emit visible light forming the images to be displayed (e.g., plasma, LED and OLED flat panels) and laser-based displays.

In operation, the screen control module 120 generates the one or more screen control signals 122 that cause the screen 101 to display images. In some implementations, a screen control signal 122 can be an electrical signal as in a plasma flat panel TV, a LCD flat panel TV or an LED flat panel TV. In other implementations, a screen control signal 122 can be an optical signal modulated to carry images, such as in some rear projection TVs and laser displays that direct laser light onto a screen. The screen control module 120 is connected in communication with the one or more conductive paths 110 formed by the screen sensors on the screen 101 to receive the screen sensor signal 112. In response to the screen sensor signal 112, the screen control module 120 affects the one or more screen control signals 122 to the display screen 101 to interfere with producing of the images at a region in a respective conductive path 110 that the sensor signal 112 indicates a discontinuity.

When the conductive paths 110 are electrical conductive paths, a damage that causes the electrical conductivity to change may cause the screen control module 120 to interfere even when an impacted conductive path 110 is not broken. For example, a change in the measured current through the screen sensor without an open circuit in the screen sensor can be used to trigger the safety response.

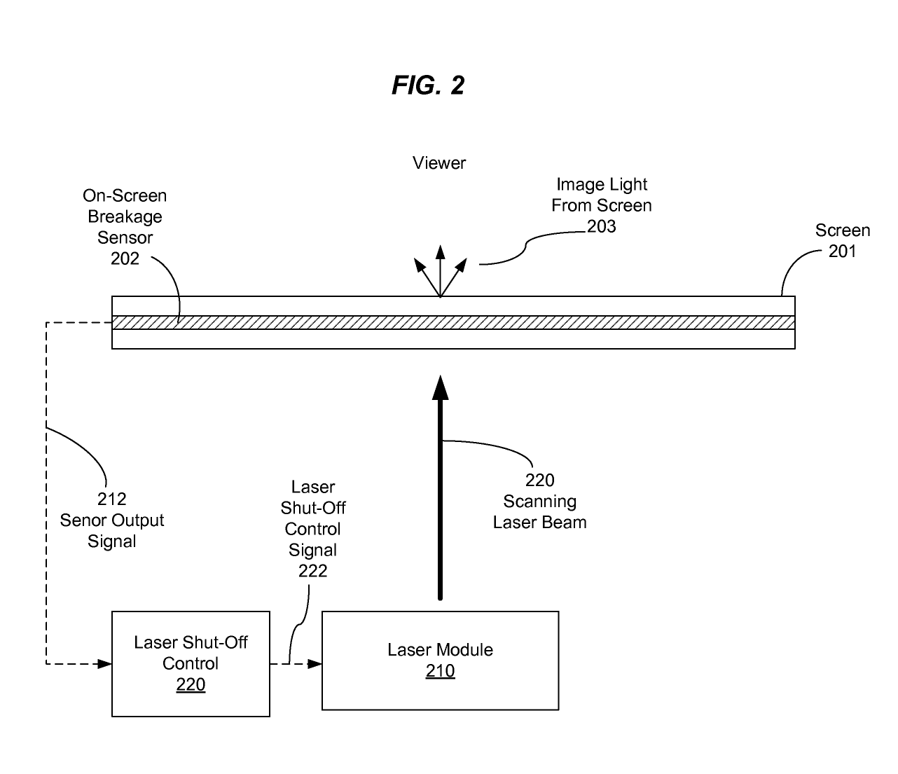

FIG. 2 shows an example of a laser-based display system that implements an on-screen sensor to detect a crack in the screen and provides automatic shutting down of the light source when a crack is detected. The screen 201 receives laser light 220, which can be, e.g., one or more scanning optical beams 120, from a laser module 210 and uses the laser light 220 to produce images which are represented by image light 203 from the screen 201. Notably, the screen 201 includes a screen sensor 202 that is embedded in a layer of the screen 201 and spatially distributes at different locations of the screen 201 in the area where the image light 203 is present during operation of the system. The screen sensor 202 can have spatially distributed sensor elements embedded in a screen layer. As a damage to the screen layer of the screen 202 occurs, one or more sensor elements at the locale of the damage in the screen layer are physically damaged, altered or broken to cause generation of a sensor signal 212 indicating the damage. The spatially distributed sensor elements may be connected to form a network of spatially distributed sensor elements and a damage to one or more adjacent sensor elements can be represented by the sensor signal 212. For example, the spatially distributed sensor elements may be electrically conductive elements and a damage to one or more adjacent sensor elements effectuates a local break or change in the electrical conductivity, which can be represented by the sensor signal 212. Certainly, other types of conductivity may also be used as the sensing mechanism for the sensor 202. This sensor 202 is located in the screen 201 and thus is an on-screen screen breakage sensor.

FIG. 2 also shows a light shut-off control module 220 that is provided to receive the sensor output signal 212 from the sensor 202 and to process the received sensor output signal 212 to control the laser module 210. The light shut-off control module 220 produces and sends a control signal 222 to the laser module 210 based on whether or not the received sensor output signal 212 indicates a damage in the screen 201. When the sensor output signal 212 indicates such a damage, the laser module 210 responds to the control signal 222 from the light shut-off control module 220 and shuts off the one or more optical beams 220.

The screen sensor 202 can be embedded in a layer in the screen 201. As an example, the screen sensor 202 can be located in a front substrate facing the viewer or another layer. The embedded screen sensor 202 can be an electrical sensor with one or more electrical conductive paths distributed over the screen 201 and a break in electrical conductive paths can be used to indicate a damage to the screen 201. Under this design, the screen sensor is a resistance sensor that measures an electrical resistance of the screen sensor 202 associated with whether there is a damage in the screen sensor 202. Since the electrical conductive paths of the sensor 202 are distributed over the screen 201, the electrical conductive material used for the sensor 202 can be optically transparent, such as indium tin oxide (ITO).

In other implementations, the laser shut-off control 220 can be replaced by a laser safety control module that controls the laser module to redirect the laser beam 220 away from the identified suspect region without shutting down the laser.

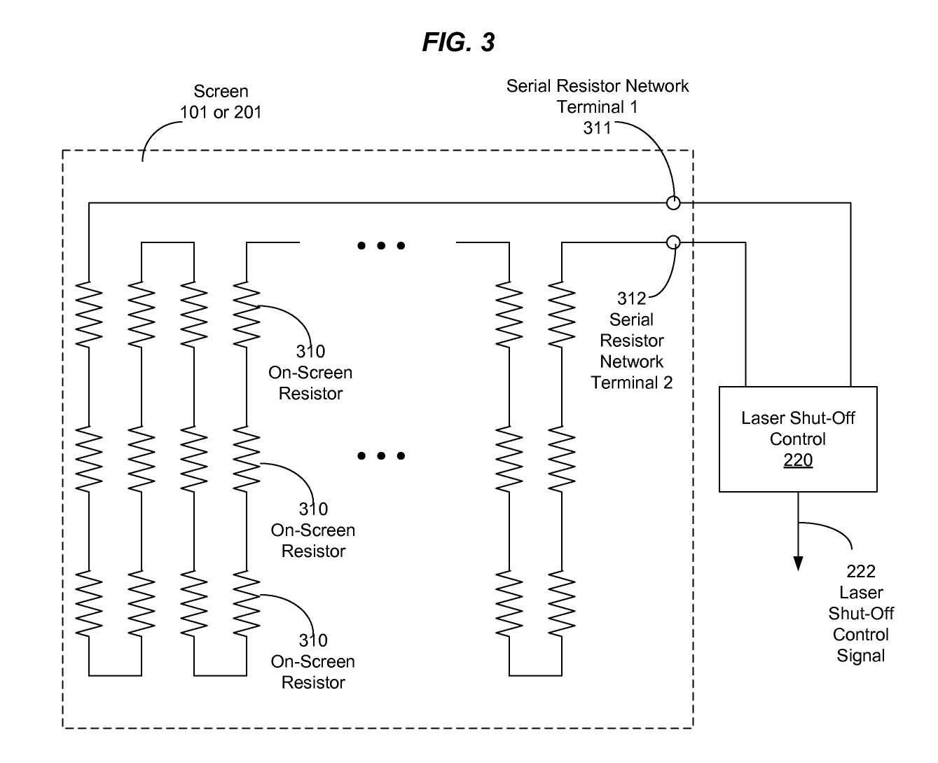

FIG. 3 shows an exemplary implementation of the screen sensor as a resistance sensor. In one layer of the screen 101 or 201, on-screen resistors 310 are the spatially distributed sensor elements and are placed across a selected area that covers at least the image-forming area of the screen 101 or 201. The resistors 310 can be arranged in vertical columns as shown in the example in FIG. 3 and are electrically connected in series. The on-screen resistors 310 can certainly be arranged in other patterns. Two terminals 311 and 312 of the connected resistor network are connected to the laser shut-off control 220 in the example in FIG. 2 or the screen control module 120 in the example in FIG. 1. In one implementation, the laser shut-off control 220 injects a monitor current through the resistor network. When the monitor current disappears, the laser shut-off control 220 uses the laser shut-off control signal 222 to shut off the laser module 210. Other electrical circuit elements other than resistors may also be used as the sensor elements. The selection of the sensor elements and the associated circuitry for the sensor are designed to provide sensitive detection.

The laser-based display system in FIG. 2 can be a scanning-beam display system in which one or more optical beams are scanned over a screen to form images on the screen. The one or more scanning optical beams can be laser beams generated from lasers to provide sufficient optical power to achieve a desired display brightness on the screen. In some implementations of such a display system, the screen may be a passive screen that does not emit light and uses the light of the one or more scanning optical beams to form the images by reflecting, diffusing or scattering the light of the one or more scanning optical beams. In other implementations, the screen of such a display system may have light-emitting materials that absorb the light of the one or more scanning optical beams and emit new light that forms the images and the light of the one or more scanning optical beams is not directly used in forming the images seen by a viewer. The beam scanning in various scanning-beam display systems can be achieved by, e.g., using one or more beam scanners. Some laser display systems use a polygon scanner with multiple reflective facets to provide horizontal scanning and a vertical scanning mirror such as a galvo-driven mirror to provide vertical scanning. In operation, one facet of the polygon scanner scans one horizontal line as the polygon scanner spins to change the orientation and position of the facet and the next facet scans the next horizontal line. The horizontal scanning and the vertical scanning are synchronized to each other to project images on the screen.

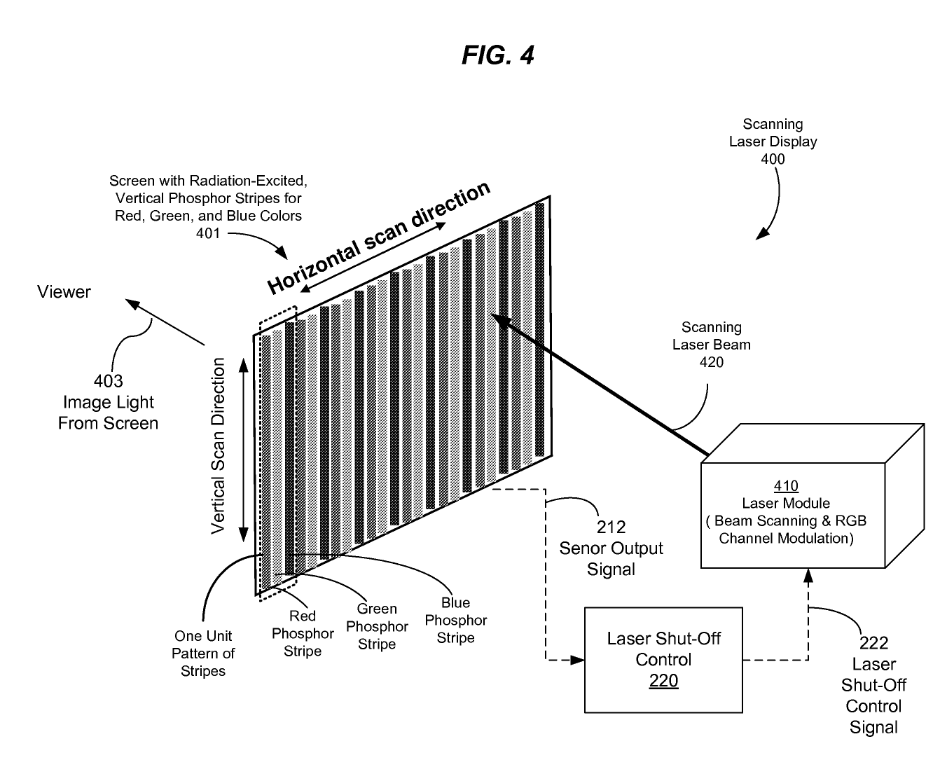

FIG. 4 shows an example of a scanning-beam display system 400 in a rear-projection configuration where the light source and a viewer on two opposite sides of the display screen. This system includes a light module 410 that produces one or more scanning optical beams 420 that are scanned along two different directions, e.g., the horizontal direction and the vertical direction, in a raster scanning pattern on a screen 401. A beam scanning mechanism inside the light module 410 scans a beam 420 horizontally and vertically to render one image frame at a time on the screen 401. The light module 410 also includes a signal modulation mechanism to modulate each beam 420 to carry the information for image channels for red, green and blue colors. The screen 401 receives the light of the one or more scanning optical beams 420 on one side of the screen 401 and outputs image light 403 on the other side (i.e., the viewer side) of the screen 401. A viewer at the viewer side of the screen 401 receives the image light 403 to view images carried by the image light 103. The light module 410 can be a laser module that has one or more lasers that produce laser light forming the optical beam 420 that is scanned onto the screen 401. Some implementations of such systems use a single scanning laser beam 420 while other implementations use two or more scanning laser beams 420.

The scanning-beam display system 400 can use a passive screen that directly uses received light of one or more scanning optical beams to form images without emitting new light. As an example, laser beams 420 in red, green and blue can be scanned on such a passive screen 401 and the screen 401 diffuses light of the red, green and blue laser beams 420 to produce the image light 401 for colored images on the other side of the screen 401. In other implementations of the scanning-beam display system 400, the screen 401 can include light-emitting materials or fluorescent materials to emit new light under optical excitation of received light of one or more scanning optical beams 420 to produce the visible image light 403 towards the viewer. Under this design, the image light 403 is emitted by the light-emitting materials or fluorescent materials of the screen 401 at wavelengths different from that of the light of one or more scanning optical beams 420.

As illustrated, a scanning optical beam 420 is a directional beam, and the image light 403 output by the screen 401 under illumination by the scanning optical beam 420 is diffused light in a wide angular range towards the viewer side of the screen 401 to provide a wide viewing angle. The intensity of the image light 403 is maintained sufficiently high for a desired display brightness while being kept under a threshold intensity level in compliance with one or more laser safety standards. Examples of some laser safety standards are American National Standards Institute (ANSI) Z136.1 Standard (Z136.1-2000) assigning lasers into one of four broad hazard Classes 1, 2, 3a, 3b and 4, the Federal Laser Product Performance Standard (FLPPS) from the Center for Devices and Radiological Health (CDRH), and the International Electrotechnical Commission (IEC) laser safety standard 60825-1. For the system 400 to be a safe commercial product, the image light 403 output by the screen 401 in the system 400 can be designed to be below the intensity level specified by Class 1 of the ANSI and IEC standards so that the image light 403 cannot cause eye or skin injury during normal operation of the system 400. Different from the image light 403, the intensity of a scanning beam 420 can be at a sufficiently high level that may cause eye or skin injury when a person is directly exposed to the scanning beam 420 in order to achieve a desired brightness of the images produced by the screen 401. To prevent direct contact of the one or more scanning beams 420 with a viewer, the screen 401 is designed to block the light of the scanning beam 420 while allowing the image light 403 to reach the viewer side. In addition, a display housing 403 is provided in the system 400 to enclose the laser module 410, the optical paths of the scanning beams 420 between the laser module 410 and the screen 401 and other system components so that the light of the one or more scanning beams 420 cannot leak out to cause harmful effects to a person near the system 400.

The screen 401 of the system 100 can be damaged to cause one or more cracks through which the one or more scanning beams 420 can pass through to reach a person. The damaged screen 401 may have a crack that allows the directional optical beam 420 to partially or entirely pass through the crack to reach the viewer side. This condition can be dangerous because the optical beam 420 may cause injury to a viewer or a person in the viewer side of the system 400. This undesired condition can be prevented by providing a screen sensor embedded in the screen 401 based on the examples in FIGS. 1-3 to measure the presence of the crack and a laser control mechanism to shut off the laser module 410 when the screen sensor detects a crack on the screen 401. This screen sensor embedded in the screen 401 can be designed to have various sensor portions that are spatially distributed across the screen 401 and are embedded in a way that the crack in the screen 401 can physically break up or damage one or more sensor portions of the screen sensor. The physical break-up or damage to the one or more sensor portions of the screen sensor can be used to generate a sensor signal to indicate a damage in the screen 401. Once the sensor signal indicates the damage to the screen 401, the light source for producing the one or more scanning beams 420 in the system 400 is shut off. The screen sensor embedded in the screen 401 detects the damage to the screen 101 rather than light of the one or more scanning beams 420 that leaks out of the screen 101. Therefore, the one or more scanning beams 420 are shut off as long as the sensor signal indicates the damage to the screen 401 regardless whether there is an actual leakage of the light of the one or more scanning beams 420. Therefore, this screen breakage sensing mechanism is preventive in nature and provides better safety protection than a laser safety mechanism that reacts based on leakage of the light of the one or more scanning beams 420 by the damaged screen 401.

As a specific example for implementing the system in FIG. 4, the screen 401 can be a light-emitting screen made of laser-excitable light-emitting materials (e.g., phosphors) emitting colored light at different visible wavelengths (e.g., red, green and blue) under excitation of the scanning laser beam 420 that carries the image information to be displayed. Various examples of screen designs with light-emitting or fluorescent materials can be used. In one implementation, for example, three different color phosphors that are optically excitable by the laser beam to respectively produce light in red, green, and blue colors suitable for forming color images may be formed on the screen as pixel dots or repetitive red, green and blue phosphor stripes in parallel. Phosphor materials are one type of fluorescent materials. Other optically excitable, light-emitting, non-phosphor fluorescent materials may also be used. For example, quantum dot materials emit light under proper optical excitation and thus can be used as the fluorescent materials for systems and devices in this application. The scanning laser beam 420 carries the images but does not directly produce the visible image light 403 seen by a viewer. Instead, the color light-emitting fluorescent materials on the screen 401 absorb the energy of the scanning laser beam 420 and emit visible light in red, green and blue or other colors to generate actual color images seen by the viewer.

Laser excitation of the fluorescent materials using one or more laser beams with energy sufficient to cause the fluorescent materials to emit light or to luminesce is one of various forms of optical excitation. In other implementations, the optical excitation may be generated by a non-laser light source that is sufficiently energetic to excite the fluorescent materials used in the screen. Examples of non-laser excitation light sources include various light-emitting diodes (LEDs), light lamps and other light sources that produce light at a wavelength or a spectral band to excite a fluorescent material that converts the light of a higher energy into light of lower energy in the visible range. The excitation optical beam that excites a fluorescent material on the screen can be at a frequency or in a spectral range that is higher in frequency than the frequency of the emitted visible light by the fluorescent material. Accordingly, the excitation optical beam may be wavelengths between 400 nm and 470 nm.

As a specific example, the screen 401 has parallel color phosphor stripes in the vertical direction and two adjacent phosphor stripes are made of different phosphor materials that emit light in different colors. Red phosphor absorbs the laser light to emit light in red, green phosphor absorbs the laser light to emit light in green and blue phosphor absorbs the laser light to emit light in blue. Adjacent three color phosphor stripes are in three different colors. One particular spatial color sequence of the stripes is red, green and blue. Other color sequences may also be used. The laser beam 420 is at the wavelength within the optical absorption bandwidth of the color phosphors and is usually at a wavelength shorter than the visible blue and the green and red colors for the color images. The laser module 410 can include one or more lasers such as UV diode lasers to produce the beam 420, a beam scanning mechanism to scan the beam 420 horizontally and vertically to render one image frame at a time on the screen 401, and a signal modulation mechanism to modulate the beam 420 to carry the information for image channels for red, green and blue colors. Examples of implementations of various features, modules and components in the scanning laser display system in FIG. 1 are described in U.S. patent application Ser. No. 10/578,038 entitled “Display Systems and Devices Having Screens With Optical Fluorescent Materials” and filed on May 2, 2006 (U.S. Patent Publication No. US 2008/0291140A1), PCT Patent Application No. PCT/US2007/004004 entitled “Servo-Assisted Scanning Beam Display Systems Using Fluorescent Screens” and filed on Feb. 15, 2007 (PCT Publication No. WO 2007/095329), PCT Patent Application No. PCT/US2007/068286 entitled “Phosphor Compositions For Scanning Beam Displays” and filed on May 4, 2007 (PCT Publication No. WO 2007/131195), PCT Patent Application No. PCT/US2007/68989 entitled “Multilayered Fluorescent Screens for Scanning Beam Display Systems” and filed on May 15, 2007 (PCT Publication No. WO 2007/134329), and PCT Patent Application No. PCT/US2006/041584 entitled “Optical Designs for Scanning Beam Display Systems Using Fluorescent Screens” and filed on Oct. 25, 2006 (PCT Publication No. WO 2007/050662). The disclosures of the above-referenced patent applications are incorporated by reference in their entirety as part of the disclosure of this document.

In the screen 401 with phosphor stripes, the phosphor stripes can be divided by stripe dividers made of an electrically conductive material such as chrome and are surrounded by borders that are also made of an electrically conductive material. Therefore, the two ends of the stripe dividers can be electrically shorted to form the on-screen sensor shown in FIGS. 2 and 3. Adjacent stripe dividers can be grouped together and electrically shorted to form one on-screen sensor element which is connected in series with other grouped stripe dividers.

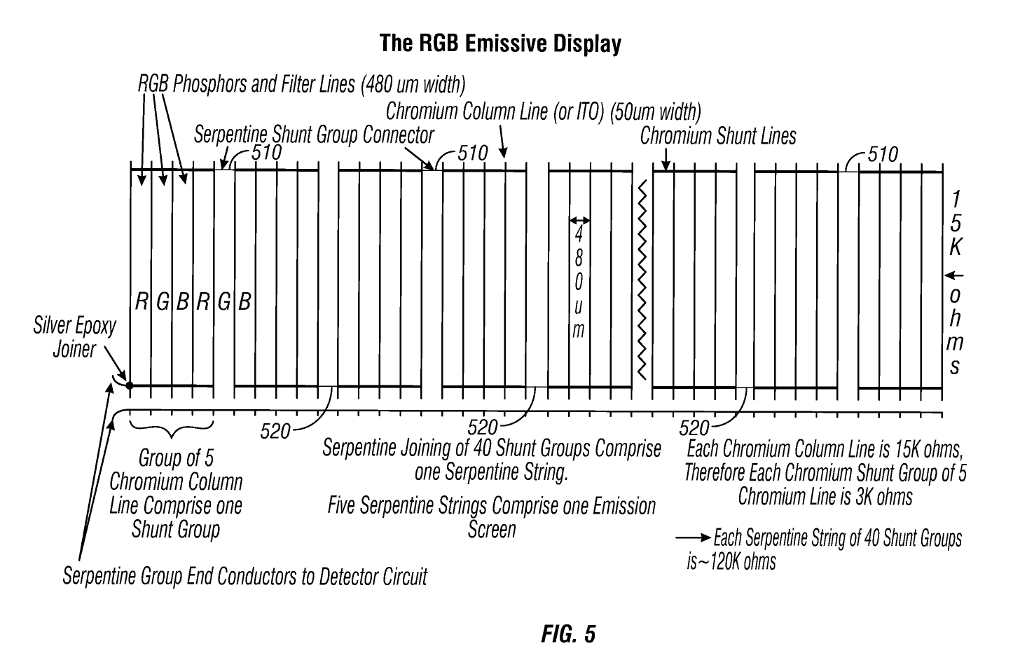

The connection between different sensor elements in the above screen example can be made in various configurations. FIG. 5 shows an example of an on-screen sensor in which a serpentine connection is made between different sensor elements. In this example, adjacent five stripe dividers formed by a conductive material such as chromium are shorted at their top and bottom ends to form a single sensor element. Top conductive connectors 510 and bottom conductive connectors 520 are used to connect the sensor elements each formed by five adjacent strip dividers. In one embodiment the top conductive connectors and the bottom conductive connectors are chrome as are the stripe dividers. For a sensor element located between two adjacent sensor elements, the middle sensor element is connected to one adjacent sensor element by a top conductive connector while being connected to the other adjacent sensor element by a bottom conductive connector 520. This design forms a serpentine pattern for the top and bottom conductive connectors 510 and 520. One benefit of this design is to reduce the total resistance of the sensor.

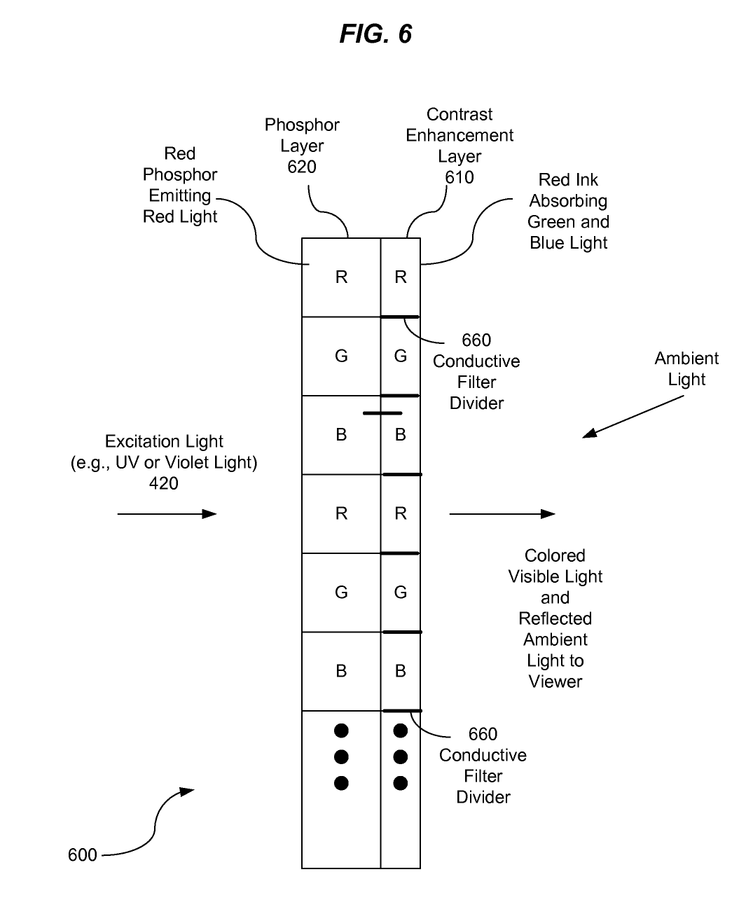

Some screens can be implemented to include a contrast enhancement layer with optical filters that selectively absorb light of red, green and blue colors. This contrast enhancement layer can be used in various screen designs. FIG. 6 shows one example of a screen 600 that uses a contrast enhancement layer 610 on the viewer side of the phosphor layer 620 for the scanning laser display in FIG. 4. The phosphor layer 4520 includes parallel phosphor stripes. Accordingly, the contrast enhancement layer 610 also includes matching parallel stripes made of different materials. For a red phosphor stripe that emits red light in response to excitation by the excitation light (e.g., UV or violet light), the matching stripe in the contrast enhancement layer 610 is made of a “red” material that transmits in a red band covering the red light emitted by the red phosphor and absorbs or otherwise blocks other visible light including the green and blue light. Similarly, for a green phosphor stripe that emits green light in response to excitation by UV light, the matching stripe in the contrast enhancement layer 610 is made of a “green” material that transmits in a green band covering the green light emitted by the green phosphor and absorbs or otherwise blocks other visible light including the red and blue light. For a blue phosphor stripe that emits blue light in response to excitation by UV light, the matching stripe in the contrast enhancement layer 610 is made of a “blue” material that transmits in a blue band covering the blue light emitted by the blue phosphor and absorbs or otherwise blocks other visible light including the green and red light. In FIG. 6, these matching parallel stripes in the contrast enhancement layer 610 are labeled as “R,” “G” and “B,” respectively. Hence, the contrast enhancement layer 610 includes different filtering regions that spatially match the fluorescent regions and each filtering region transmits light of a color that is emitted by a corresponding matching fluorescent region and blocks light of other colors. The different filtering regions in the layer 610 may be made of materials that absorb light of other colors different from the color emitted by the matching fluorescent region. Examples of suitable materials include dye-based colorants and pigment-based colorants. In addition, each of the R, G and B materials in the contrast enhancement layer 610 may be a multi-layer structure that effectuates a band-pass interference filter with a desired transmission band. Various designs and techniques may be used for designing and constructing such filters. U.S. Pat. No. 5,587,818 entitled “Three color LCD with a black matrix and red and/or blue filters on one substrate and with green filters and red and/or blue filters on the opposite substrate,” and U.S. Pat. No. 5,684,552 entitled “Color liquid crystal display having a color filter composed of multilayer thin films,” for example, describe red, green and blue filters that may be used in the design in FIG. 6.

In operation, the UV excitation light enters the phosphor layer 620 to excite different phosphors to emit visible light of different colors. The emitted visible light transmits through the contrast enhancement layer 610 to reach the viewer. The ambient light incident to the screen enters the contrast enhancement layer 610 and a portion of the ambient light is reflected towards the viewer by passing through the contrast enhancement layer 610 for the second time. Hence, the reflected ambient light towards the viewer has transmitted the contrast enhancement layer 610 and thus has been filtered twice. The filtering of the contrast enhancement layer 610 reduces the intensity of the reflected ambient light by two thirds. As an example, the green and blue portions comprise approximately two thirds of the flux of the ambient light entering a red subpixel. The green and blue are blocked by the contrast enhancement layer 610. Only the red portion of the ambient light within the transmission band of the red filter material in the contrast enhancement layer 610 is reflected back to the viewer. This reflected ambient light is essentially the same color for the subpixel generated by the underlying color phosphor stripe and thus the color contrast is not adversely affected.

Notably, the on-screen sensor described above, e.g., the sensor in FIG. 5 in the phosphor layer, can be implemented by conductive filter dividers 660 in the contrast enhancement layer 610 of color filters. The conductive filter dividers 660 can be connected based on the example in FIG. 5 to form a serpentine pattern from the parallel conductive filter dividers 660.

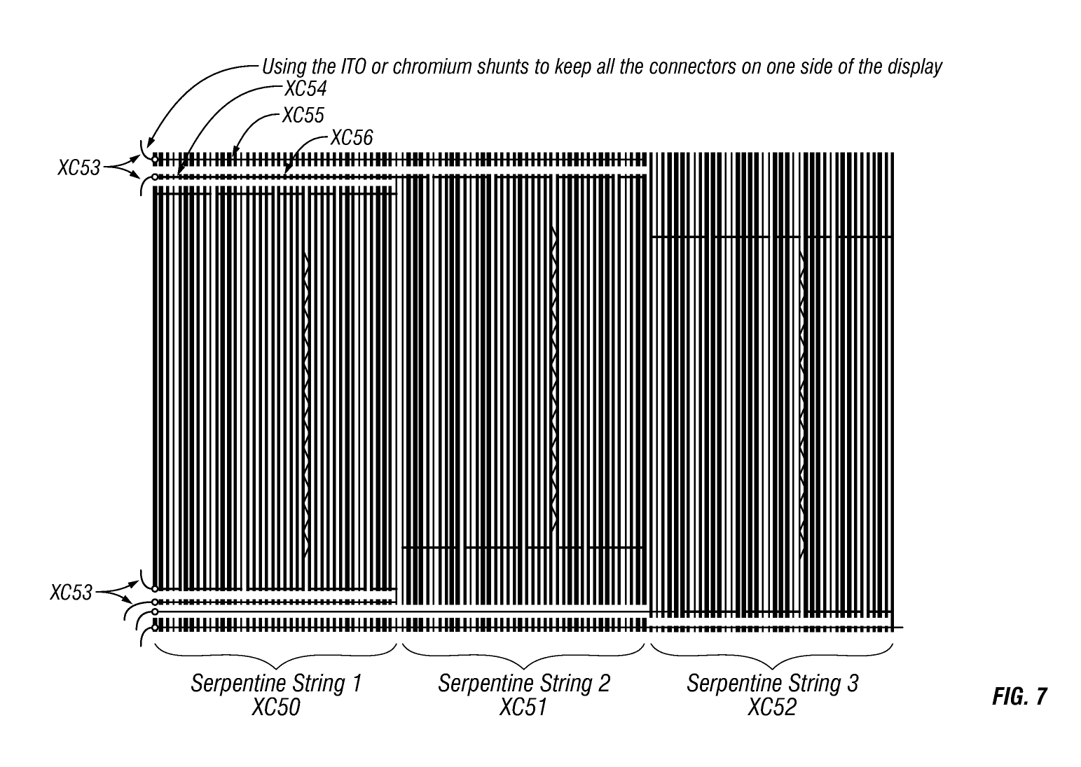

FIG. 7 shows another example of a serpentine connection pattern for connecting parallel dividers that are in a phosphor layer, a filter layer or in another screen layer to form the on-screen sensor. Three serpentine strings XC50, XC51, XC52 are simultaneously configured utilizing the chromium filter separators as means to design for a specific conduction current break detection sensitivity circuit. The conductive dividers may in addition to run along the side of the stripes and may cross the stripes themselves by intersecting the stripes with additional strips of chromium. By crossing the phosphor stripes with chromium cross strips 510 and 520 as shown in FIG. 5, new current conduction paths to augment the break detection conduction paths can be introduced, while still allowing for mostly full emission capability of the UV impinged phosphor stripes.

In the example shown in FIG. 7, serpentine string 2 XC51, has input/output path XC54 and XC55. The input/output path XC54 chromium conduction path crosses and electrically shunts across multiple chromium filter separators XA5. To insure a proper conduction path for proper break detection of the serpentine string 2 XC51 conduction path, the input/output path XC55 chromium conduction path crosses and electrically shunts across multiple chromium filter separators XA5 in a manner that does not create an electrical short between input/output path XC54 and input/output path XC55. this is achieved by introducing an electrical break in the chromium filter separator XA5 lines that cross input/output path XC54 and XC55, by introducing an electrical open between input/output paths XC54 and XC55 along the corresponding chromium filter separators XA5 that overlap the two input/output paths.

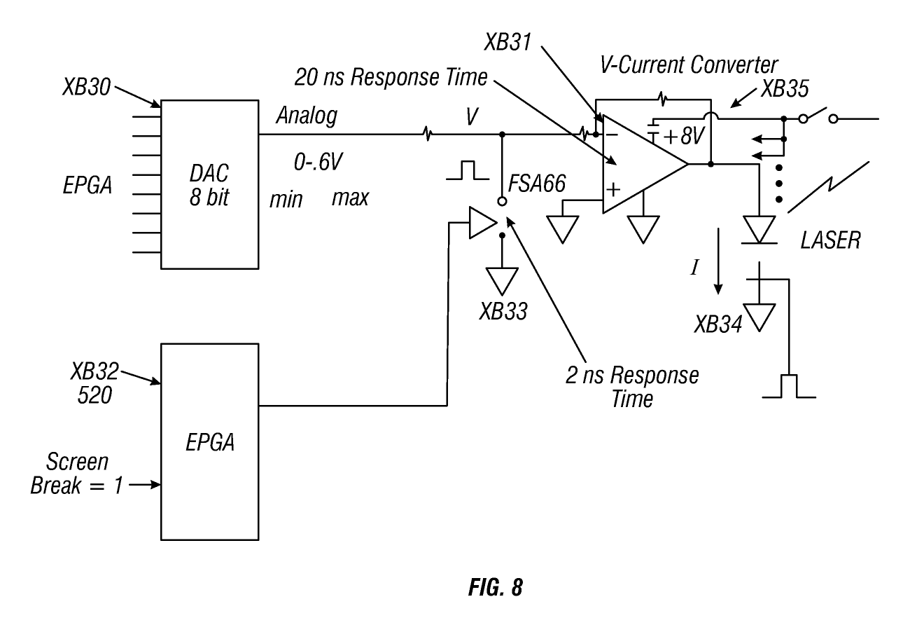

Referring back to the system in FIG. 4 where one or more laser diodes are used to produce the one or more laser beams 420 to energize the screen 401, the laser shut-off mechanism based on the on-screen sensor can be implemented by a laser control circuit shown in an example in FIG. 8. In this example, the control of the laser is altered by controlling the laser current rather than shutting down the power supply because the radiation energy needs to be controlled within a level that is directly related to the amount of the exposure time. In this case, in order for the product to meet laser safety criteria, the switching time is set to be less than 100 nsec. When the conductive path in the screen sensor is broken, the control of the laser is affected in a manner that the laser is brought to a low excitation strength. As illustrated, a Digital Analog Converter (DAC) XB30 drives the normal control operation of the laser source driver. The DAC XB30 is operated to control the current provided from the power supply current source XB35 to the laser XB34. In normal operation the DAC XB30 sets a voltage value to the laser excitation driver XB31. The laser excitation driver XB31 controls the amount of current to be provided to the laser XB34 up to the maximum current provided by the power supply current source XB35. Depending upon the intended current to the laser, the DAC sends a 0-V signal to the laser excitation driver for a non-excitation laser stimulus setting to a 0.6-V signal to the laser excitation driver for a max-excitation laser stimulus setting. When the break in the conduction path is detected, the FPGA XB32 receives a change in current as a result of the change in the conduction current from the break detector assembly due to the break. The change in current as received by FPGA is a signal that a break may have occurred and as a result the laser is to have its current reduced quickly. The reduction of current to the laser reduces the light emanating from the laser. Turning off or sufficiently reducing the current to the laser inhibits energy emanating from the laser. When the FPGA XB32 recognizes a change in current from the conduction current from the break detector assembly, it closes the current switch XB33. This closing of the current switch drives the current to the laser excitation driver XB31 to 0. This results in a very fast change to the current to the laser which in turn becomes 0 as well. With the laser excitation driver XB31 having a response time of nearly 20 ns and the current switch XB33 having a short response time of nearly 2 ns, the time from the break detection to inhibiting the laser's emanation is under 22 ns and meets the safety criteria given the laser power and density on the screen.

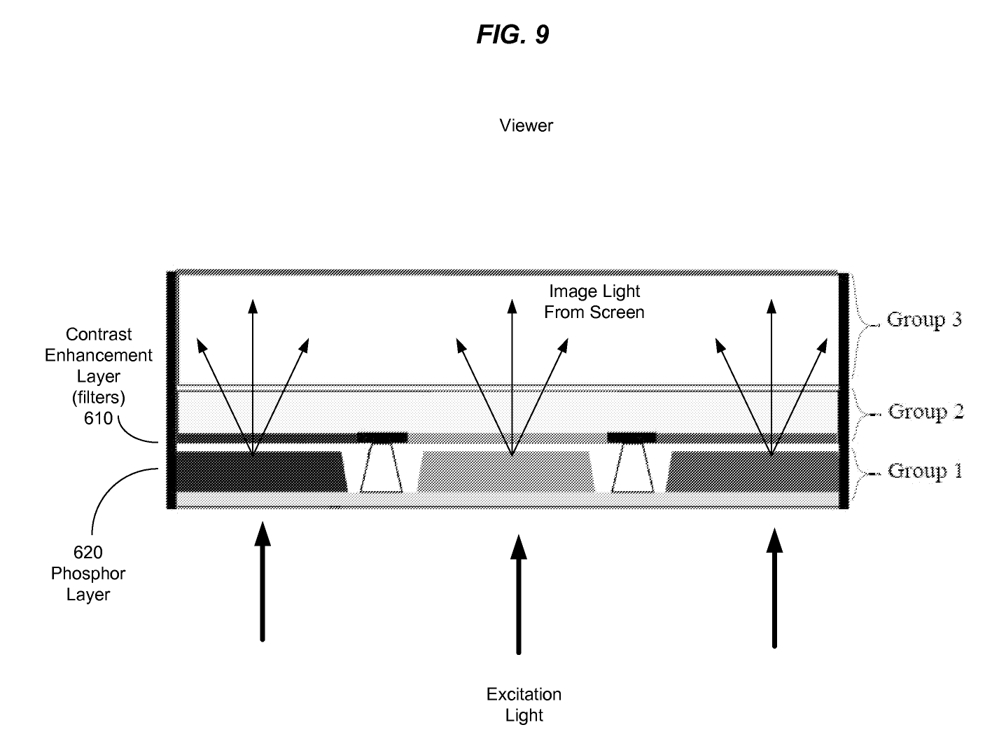

The on-screen sensor for detecting screen breakage can be embedded in a layer in a phosphor-based screen with phosphor stripes. FIG. 9 shows one example design for such a screen based on three groups of screen elements. Each group can include one or more screens. Group 1 is the phosphor layer (e.g., the layer 620 in FIG. 6) which contains three color emissive phosphors that are excitable by UV laser light. Group2 is an RGB color filter that is matched to the RGB phosphor layer (e.g., the layer 610 in FIG. 6). Group3 is the UV blocking filter that is meant to block any remanance of laser UV light to protect the viewer from eye damage. The break item is the object to be determined of whether it has broken. The break item is group 3 or the UV blocker. The UV blocker is a UV blocking material, that filter and hence prevents the passing through of UV light. The UV blocking layer can be a relatively thick or thin acrylic layer or directly deposited as a thin film on group2. In all cases, the UV blocking layer is made such as it is most resilient to breakage but if directly deposited on group2 it is directly linked to group2 breakage. The UV excitation layer group 1 is a UV-to-visible light excitation layer. The UV light XA12 excites the UV-to-visible light phosphor group 1. The phosphor receives the UV light energy and through photon luminescence creates visible light. The visible light may be one of many colors. For example in one embodiment, the excited phosphor generated red, green and blue visible light. The visible light is further filtered by the light filters group2, which filters out the unintended visible light. For example the phosphor that generates primarily red visible light may have inadvertent facilitated other colors of visible light as well. The filter will filter out the unintended non-red additional visible light. The UV light energy that impinges onto the phosphor group1 also passes through the visible light filters group2 (attenuated) and into the UV blocking layer group3.

In one implementation of the screen in FIG. 9, the filter group 2 is a thin piece of glass which has the color filters separated by physically conductive chromium lines. The thin piece of glass is approximately 1 mm thick. These chromium filter separators chromium, are black and hence absorbs visible and UV light that would otherwise pass across to the viewer. The chromium is also a conductive material acts as part of the break detection system when connected to each other in various configurations. The thin piece of glass of Group 2 has a higher susceptibility to breakage or fracture than the protector layer group3. When the panel is compromised into a break condition by some external physical force, the proximity to the thin glass of group 2 to group 3 together with the fragility of the thin glass can cause a break in the conduction path of the chromium separators. Alternatively, group1 can have a conductive separator layer between the RGB phosphor stripes as long as group1 is to break first.

In another implementation where the RGB filters are not separated by conductive chromium, it is possible to pattern through masking operation a transparent ITO layer directly on the group3. The transparency is provided to avoid any image print through or obscuration due to the ITO—alternatively the ITO can be deposited to match the separation between the RGB lines.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, variations and enhancements of the described implementations and other implementations can be made based on what is described and illustrated in this document.

What is claimed is:

1. A display device, comprising:
a display screen assembly that produces images in response to one or more screen control signals, the display screen assembly comprising screen sensors spatially distributed at different locations in the display screen assembly and connected to form one or more continuous conductive paths, each conductive path carrying a sensor signal indicating whether there is a discontinuity of the display screen assembly at or near the respective conductive path; and
a screen control module that receives the sensor signal carried by the one or more screen sensors and affects the one or more screen control signals to the display screen assembly to interfere with producing of the images at a region in a respective conductive path that the sensor signal indicates a discontinuity.

2. The device as in claim 1, wherein:
the screen sensors embed in a layer in the display screen.

3. The device as in claim 1, wherein:
the conductive paths of the screen sensors overlap with an area of the display screen displaying images without interfering with displaying of the images and are imperceptible to a viewer.

4. The device as in claim 1, wherein:
each screen sensor is a resistance sensor that measures an electrical resistance of the screen sensor associated with whether there is a discontinuity in the screen sensor.

5. The device as in claim 4, wherein:
the resistance sensor comprises electrically conductive elements at different locations of the screen assembly.

6. The device as in claim 5, wherein:
the electrically conductive elements are optically transparent.

7. The device as in claim 4, wherein:
the resistance sensor comprises electrically conductive parallel stripes on the display screen assembly and are electrically connected to form the one or more conductive paths.

8. The device as in claim 7, wherein:
the electrically parallel stripes are divided into different groups of adjacent electrically conductive parallel stripes, wherein first ends of adjacent electrically conductive parallel stripes in each group are electrically shorted to form a first group terminal and second, opposite ends of adjacent electrically conductive parallel stripes in each group are electrically shorted to form a second group terminal, and
the different groups of adjacent electrically conductive parallel stripes are electrically connected to one another in series.

9. The device as in claim 1, comprising:
a light source module that produces one or more scanning optical beams having optical pulses to carry imaging data for the images to be displayed on the display screen assembly;
wherein the display screen assembly comprises parallel light-emitting stripes which absorb light of the one or more scanning optical beams to emit visible light to produce images carried by the one or more scanning optical beams, and electrically conductive stripe dividers parallel to and spatially interleaved with the light-emitting stripes with each stripe divider being located between two adjacent stripes, and
the electrically conductive stripe dividers are electrically connected to form the screen sensors.

10. The device as in claim 1, comprising
a light source module that produces one or more scanning optical beams having optical pulses to carry imaging data for the images to be displayed on the display screen assembly,
a layer of light-emitting materials in the display screen assembly to absorb light of the one or more scanning optical beams to emit visible light which forms images, and
a screen filter layer located on one side of the display screen assembly opposite to a side that faces the light source so that the layer of light-emitting materials is positioned between the light source and the screen filter layer, the screen filter layer structured to transmit the visible light emitted by the light-emitting materials and block light of the one or more optical beams from the light source,
wherein each screen sensor is embedded in the screen filter layer and is formed by connected conductive elements in the screen filter layer.

11. The device as in claim 1, wherein:
the display screen assembly is a liquid crystal display panel.

12. The device as in claim 1, wherein:
the display screen assembly is a plasma display panel.

13. The device as in claim 1, wherein:
the display screen assembly is a panel comprising light emitting pixel elements that emit visible light forming the images to be displayed.

14. A display device, comprising:
a light source module that produces one or more scanning optical beams having optical pulses to carry image information;
a display screen positioned to receive the one or more scanning optical beams from the light source module and comprising different light-emitting regions that absorb the one or more scanning optical beams to emit visible light forming images, the display screen comprising a screen sensor that comprises electrically conductive segments spatially distributed at different locations of the display screen and connected to form a continuous electrically conductive path to carry a sensor signal indicative of a damage in the display screen when the damage in the screen breaks the conductive path of the screen sensor; and
a light shut-off control module that receives the sensor signal from the screen sensor and controls the light source to shut off the one or more scanning optical beams when the sensor signal indicates a damage in the display screen.

15. The system as in claim 14, wherein:
the screen sensor is a resistance sensor that measures an electrical resistance of the conductive path.

16. The system as in claim 14, wherein:
the electrically conductive elements are optically transparent.

17. The system as in claim 14, wherein:
the different light-emitting regions of the display screen comprise parallel light-emitting stripes which absorb light of the one or more scanning optical beams to emit visible light to produce images carried by the one or more scanning optical beams, and electrically conductive stripe dividers parallel to and spatially interleaved with the light-emitting stripes with each stripe divider being located between two adjacent stripes, and
the electrically conductive stripe dividers are electrically connected to form the conductive path of the screen sensor.

18. The system as in claim 17, wherein:
the electrically conductive stripe dividers are divided into different groups of adjacent electrically conductive stripe dividers, wherein first ends of adjacent electrically conductive stripe dividers in each group are electrically shorted to form a first group terminal and second, opposite ends of adjacent electrically conductive stripe dividers in each group are electrically shorted to form a second group terminal, and
the different groups of adjacent electrically conductive stripe dividers are electrically connected to one another in series to form the resistance sensor.

19. The system as in claim 14, wherein:
the display screen comprises:
a layer of light-emitting materials that emit visible light which forms images after absorbing light of the one or more optical beams, and
a screen filter layer located on one side of the screen opposite to a side that faces the light source so that the layer of light-emitting materials is positioned between the light source and the screen filter layer, the screen filter layer structured to transmit the visible light emitted by the light-emitting materials and block light of the one or more optical beams from the light source, wherein the screen filter layer comprises electrically conductive segments that are connected to form the conductive path of the screen sensor so that the screen sensor is embedded in the screen filter layer.

20. A method for detecting discontinuities in a display screen assembly, comprising:
energizing one or more conductive paths in a display screen assembly that are formed by connecting conductive segments spatially distributed at different locations in the display screen assembly to effectuate a screen sensor that carries a sensor signal to indicate one or more discontinuities in the one or more conductive paths; and
controlling the display screen assembly to substantially remove images displayed on the display screen assembly at a location on the screen display assembly in response to the sensor signal when the sensor signal indicates presence of one or more discontinuities in the display screen assembly.

21. The method as in claim 20, wherein:
the display screen assembly produces images by receiving light carrying images, and
the controlling the display screen assembly to substantially remove images includes shutting off the light carrying images or redirecting the light away from a location where a discontinuity is present.

22. The method as in claim 20, wherein:
the display screen assembly comprises screen pixels that are electrically energized to produce images, and
the controlling the display screen assembly to substantially remove images includes shutting off electrical power to the screen pixels.
